(19) United States
(12) Patent Application Publication
(10) Pub. No.: US 2007/0130160 A1
(43) Pub. Date: Jun. 7, 2007

(54) SYSTEM AND METHOD FOR SUPPORTING PORTABLE APPARATUS

(75) Inventors: Sung Ho Choe, Yongsan-gu (KR); Woo Seok Kim, Yongsan-gu (KR)

Correspondence Address: FISH & RICHARDSON P.C., P.O. BOX 1022, MINNEAPOLIS, MN, 55440-1022, US

(73) Assignee: LG Electronics, Youngdungpo-gu (KR)

(21) Appl. No.: 11/530,406

(22) Filed: Sep. 8, 2006

(30) Foreign Application Priority Data
Dec. 6, 2005 (KR) 10-2005-0118414

(51) Int. Cl. G06F 17/30

(52) U.S. Cl. 707/10

(57) ABSTRACT

Disclosed is a support system and method proper for support of a portable apparatus. In the system and method a periphery control module controls the portable apparatus. A communication module intermediates communication with a communication network. An input controller controls input of a command from a user. A control module reads the DRM information from the portable apparatus, searches for on-line a data file appointed through the input controller by the user based on the read DRM information, and downloads the searched data file to the portable apparatus through the periphery control module, when a connection of the portable apparatus with the periphery control module is detected.

This application claims priority to Korean Patent Application Nos. 10-2005-0118413 and 10-2005-0118414, filed in the Korean Industrial Property Office on Dec. 6, 2005, and on Dec. 6, 2005, respectively, as verified by the submitted certificate(s).

### BACKGROUND OF THE INVENTION

1. Field of the Invention

The present invention relates to a system and method for supporting a portable apparatus.

2. Description of the Prior Art

Typical portable apparatuses enable a user to transmit, receive, listen to, and/or view information, even while the user is moving. Portable apparatuses are evolving from single-function apparatuses, such as a portable telephone, a portable reproducer, and a portable receiver, into multimedia apparatuses having various reproduction functions. In order to implement signal processing and control, such portable apparatuses are currently employing software blocks which can replace a considerable number of hardware blocks. This replacement is based on the fact that it is easier to add functions, process signals according to using environments, and change control logics by using software blocks than by using hardware blocks.

In such a portable apparatus including circuit blocks implemented by software, it is inevitable that problems may frequently occur or the apparatus may frequently break. Further, a manufacturer of the portable apparatus frequently enhances or adds functions of the portable apparatus. Whenever a service for maintenance or function update is necessary, it is inevitable for a user of the conventional portable apparatus to visit an after-service center of the portable apparatus.

Meanwhile, a portable apparatus having a reproduction function enables a user to listen to or view sound and/or image information while the user is moving. It is a current trend that such a portable apparatus having a reproduction function is equipped with an embedded recording medium instead of a replaceable recording medium. In the portable apparatus equipped with an embedded recording medium, data files containing necessary sound and/or image information are downloaded to a recording medium (e.g. hard disk or non-volatile memory), and the data files stored in the recording medium is then reproduced. Such portable apparatuses equipped with an embedded recording media are being developed to store a larger number of data files in accordance with the development in the circuit-integration technology.

A Digital Right Management (DRM) means (or function) for protecting a copyright of a supplier of a data file (or a creator of sound or image information in the data file) is added to the data file which will be downloaded to the portable apparatus having a reproduction function. The DRM means is implemented by a program which prevents an unauthorized person or company from reproducing the data file. Further, the DRM means is implemented in a unique style according to the manufacturer of the data file.

According to the addition of the DRM means to the data file, the portable apparatus having a reproduction function can reproduce the data file only after releasing the DRM means. In order to release the DRM means, the portable apparatus having a reproduction function includes a DRM release function which is implemented by a program. Further, it is possible to provide the DRM release function to the portable apparatus, only when the supplier of the data file (i.e. the manufacturer or creator) supplies the DRM release function to the manufacture of the portable apparatus.

Since the DRM release function must be supplied from the supplier of the data file to the manufacturer of the portable apparatus as described above, the portable apparatus can reproduce only the data files of the DRM means corresponding to the DRM release means in itself. In other words, due to the DRM means, the conventional portable apparatus cannot reproduce the data files from all suppliers but can reproduce the data files from only some of the suppliers. Therefore, it is inevitably difficult and time-consuming to download reproducible data files by the conventional portable apparatus.

In this regard, a solution for facilitating maintenance/repair, function update, and data file downloading of a portable apparatus is highly required.

### SUMMARY OF THE INVENTION

Accordingly, the present invention has been made to solve the above-mentioned problems occurring in the prior art, and an object of the present invention is to provide a support system and method proper for support of a portable apparatus.

It is another object of the present invention to provide a support system and method for facilitating maintenance and repair of a portable apparatus.

It is still another object of the present invention to provide a support system and method for facilitating function update of a portable apparatus.

It is still another object of the present invention to provide a recording medium having an application program for facilitating maintenance, repair, and function update of a portable apparatus.

It is still another object of the present invention to provide a support system and method, which can easily download data files to a portable apparatus having a reproduction function.

It is still another object of the present invention to provide a recording medium storing an application program, which can easily download data files to a portable apparatus having a reproduction function.

It is yet still another object of the present invention to provide a portable apparatus having a reproduction function, which has an application program for facilitating download of reproducible data files.

In order to accomplish this object, there is provided a system for system for supporting a portable apparatus which stores a feature table including Digital Right Management (DRM) information, the system comprising: a periphery control module for controlling the portable apparatus; a communication module for intermediating communication with a communication network; an input controller for inputting a command from a user; and a control module which reads the DRM information from the portable apparatus, searches for on-line a data file appointed through the input controller by the user based on the read DRM information and downloads the searched data file to the portable apparatus through the periphery control module, when a connection of the portable apparatus with the periphery control module is detected.

It is preferred that the control module connects through the communication module and the communication network with a content server compatible with the portable apparatus and searches for the appointed data file in the content server based on the DRM information, and downloads the searched data file to the portable apparatus upon receiving a download command for the searched data file.

The control module requests optimization of the data file to the content server before the data file is downloaded, so that an optimized data file can be downloaded to the portable apparatus.

In accordance with another aspect of the present invention, there is provided a system for supporting a portable apparatus which stores a feature table including Digital Right Management (DRM) information, the system comprising: a periphery control module for controlling the portable apparatus: a communication module for intermediating communication with a communication network; a memory storing data files; an input controller for controlling input of a command; and a control module which reads the DRM information from the portable apparatus, and downloads data file reproducible by the portable apparatus from among the data files stored in the memory to the portable apparatus based on the read DRM information, when a connection of the portable apparatus with the periphery control module is detected.

The control module searches for on-line reproducible data files corresponding to data files irreproducible by the portable apparatus through the communication module and the communication network based on the read DRM information, and downloads the on-line searched data files to the portable apparatus through the periphery control module.

The control module connects through the communication module and the communication network with a content server compatible with the portable apparatus, searches for the reproducible data files corresponding to the irreproducible data files in the content server based on the DRM information, and downloads the searched reproducible data files to the portable apparatus.

The control module searches only irreproducible data files appointed through the input controller in order to find the reproducible data files corresponding to the irreproducible data files.

In accordance with another aspect of the present invention, there is provided a system for supporting a portable apparatus which stores a feature table including a manufacturer name and a model name, the system comprising: a periphery control module for controlling the portable apparatus; a communication module for intermediating communication with a communication network; and a control module which reads the manufacturer name and the model name from the portable apparatus, and downloads firmware corresponding to the model name to the portable apparatus from a site corresponding to the manufacturer name through the communication module and the communication network, when a connection of the portable apparatus with the periphery control module is detected.

In accordance with another aspect of the present invention, there is provided a system for supporting a portable apparatus which stores a feature table including a manufacturer name, a model name, and a serial number, the system comprising: a periphery control module for controlling the portable apparatus; a communication module for intermediating communication with a communication network: an input controller for controlling input of a command; and a control module which reads the manufacturer name, the model name, and the serial number from the portable apparatus, registers the serial number in an on-line site of a manufacturer through the communication module and the communication network based on the manufacturer name, and registers user information from the input controller to the on-line site of the manufacturer, when a connection of the portable apparatus with the periphery control module is detected.

The control module downloads an electronic coupon to the portable apparatus from the on-line site of the manufacturer, after registering the user information.

In accordance with another aspect of the present invention, there is provided a system for supporting a portable apparatus which stores a feature table including a manufacturer name, a model name, a serial number, and Digital Right Management (DRM) information, the system comprising: a periphery control module for controlling the portable apparatus; a communication module for intermediating communication with a communication network; a memory storing data files; an input controller for controlling input of a command; and a control module which reads the feature table from the portable apparatus, and selectively performs a table update mode, a firmware update mode, an on-line registration mode, a data file download mode, and an on-line download mode, when a connection of the portable apparatus with the periphery control module is detected, wherein the control module updates updatable items in the feature table of the portable apparatus in response to a command from the input controller in the table update mode, downloads firmware from a site of a manufacturer to the portable apparatus through the communication module by using the manufacturer name and the model name in the feature table in the firmware update mode, registers the serial number and user information in the site of the manufacturer through the communication module by using the manufacturer name in the feature table in the on-line registration mode, downloads reproducible data files from among the data files stored in the memory to the portable apparatus based on the DRM information in the feature table in the data file download mode, and downloads data files from a compatible content server through the communication module to the portable apparatus based on the DRM information in the on-line download mode.

In accordance with another aspect of the present invention, there is provided a method for supporting a portable apparatus comprising the steps of. (1) determining if a portable apparatus storing a feature table including Digital Right Management (DRM) information connects with a periphery control module; (2) reading the DRM information from the portable apparatus; (3) searching for a data file appointed through an input controller by a user based on the read DRM information on-line through a communication module and a communication network; and (4) downloading the searched data file to the portable apparatus through the periphery control module.

Step (3) comprises the steps of: connecting the communication module with a content server, which is compatible with the portable apparatus, through the communication network based on the DRM information; and searching for the data file appointed by the content server.

Step (4) comprises the steps of: requesting optimization of the data file to be downloaded to the content server; and receiving an optimized data file from the content server.

In accordance with another aspect of the present invention, there is provided a method for supporting a portable apparatus, comprising the steps of: waiting for a connection of a portable apparatus storing a feature table including Digital Right Management (DRM) information connects with a periphery control module of a downloading system; reading the DRM information from the portable apparatus; and downloading data files reproducible by the portable apparatus from among data files stored in a memory of the downloading system to the portable apparatus based on the read DRM information.

The method further comprises the steps of: (a) searching for data files irreproducible by the portable apparatus based on the DRM information; (b) searching for the reproducible data files corresponding to the irreproducible data files based on the read DRM information on-line through a communication module and a communication network: and (c) downloading the on-line searched reproducible data files to the portable apparatus through the periphery control module.

Step (b) comprises the steps of: connecting the communication module with a content server, which is compatible with the portable apparatus, through the communication network based on the DRM information; and searching for the reproducible data files corresponding to the irreproducible data files in the compatible content server.

Step (b) is performed only for irreproducible data files appointed through an input controller.

In accordance with another aspect of the present invention, there is provided a method for supporting a portable apparatus, comprising the steps of: determining if a portable apparatus storing a feature table including a manufacturer name and a model name is connected with a periphery control module; reading the DRM information from the portable apparatus, and connecting with a site corresponding to the manufacturer name through a communication module and a communication network based on the manufacturer name: and downloading firmware corresponding to the model name to the portable apparatus from the site corresponding to the manufacturer name.

In accordance with another aspect of the present invention, there is provided a method for supporting a portable apparatus, comprising the steps of: determining if a portable apparatus storing a feature table including a manufacturer name, a model name, and a serial number, is connected with a periphery control module; reading the manufacturer name, the model name, and the serial number from the portable apparatus; registering the serial number in a site of a manufacturer through a communication network based on the manufacturer name; and registering user information to the on-line site of the manufacturer through the communication network.

The method further comprises the step of downloading an electronic coupon to the portable apparatus from the on-line site of the manufacturer, after registering the user information.

In accordance with another aspect of the present invention, there is provided a method for supporting a portable apparatus, comprising the steps of determining if a portable apparatus storing a feature table including a manufacturer name, a model name, a serial number, and Digital Right Management (DRM) information, is connected with a periphery control module; reading the feature table from the portable apparatus: receiving a command from a user; and selectively performing a table update mode, a firmware update mode, an on-line registration mode, a data file download mode, and an on-line download mode, in response to the command from the user, wherein updatable items in the feature table of the portable apparatus are updated in response to the command from the user in the table update mode, firmware are downloaded from a site of a manufacturer to the portable apparatus through the communication module by using the manufacturer name and the model name in the feature table in the firmware update model the serial number and user information arc registered in the site of the manufacturer through the communication module by using the manufacturer name in the feature table in the on-line registration mode, reproducible data files from among the data files stored in the memory are downloaded to the portable apparatus based on the DRM information in the feature table in the data file download mode, and data files from a compatible content server through the communication module are downloaded to the portable apparatus based on the DRM information in the on-line download mode.

In accordance with another aspect of the present invention, there is provided a recording medium storing a downloading program for executing a method in a portable apparatus storing a feature table including Digital Right Management (DRM) information, the method comprising the steps of: waiting for a connection of the portable apparatus with a periphery control module of a support system; reading the DRM information from the portable apparatus; downloading data files reproducible by the portable apparatus from among data files stored in a memory of the downloading system to the portable apparatus based on the read DRM information, searching for data files irreproducible by the portable apparatus based on the DRM information; searching for the reproducible data files corresponding to the irreproducible data files based on the read DRM information on-line through a communication module and a communication network; and downloading the on-line searched reproducible data files to the portable apparatus through the periphery control module.

In accordance with another aspect of the present invention, there is provided a portable apparatus comprising the recording medium as defined above.

In accordance with another aspect of the present invention, there is provided a recording medium storing a support program for executing a method which comprises the steps of: determining if a portable apparatus storing a feature table including a manufacturer name, a model name, a serial number, and Digital Right Management (DRM) information, is connected with a periphery control module; reading the feature table from the portable apparatus; receiving a command from a user; and selectively performing a table update mode, a firmware update mode, an on-line registration mode, a data file download mode, and an on-line download mode, in IS response to the command from the user, wherein updatable items in the feature table of the portable apparatus are updated in response to the command from the user in the table update mode, firmware are downloaded from a site of a manufacturer to the portable apparatus through the communication module by using the manufacturer name and the model name in the feature table in the firmware update mode, the serial number and user information are registered in the site of the manufacturer through the communication module by using the manufacturer name in the feature table in the on-line registration mode, reproducible data files from among the data files stored in the memory are downloaded to the portable apparatus based on the DRM information in the feature table in the data tile download mode, and data files from a compatible content server through the communication module are downloaded to the portable apparatus based on the DRM information in the on-line download mode.

In accordance with another aspect of the present invention, there is provided a portable apparatus comprising the recording medium as defined above.

By the construction of the system and method according to the present invention as described above, it is possible to reset used language and frequency band according to used country or environment, performe maintenance/repair, addition of new functions, update of unstable functions of the portable apparatus. Moreover, according to the present invention, it is possible to prevent loss or robbery of the portable apparatus and to trace illegal distribution of the portable apparatus, including sale of a stolen apparatus with removal of its serial number label and dumping of the apparatus by an illegal seller. Further, it is also possible to prevent illegal use of the coupon through forgery or falsification of a sheet-type coupon and loss of privilege due to loss of the sheet-type coupon.

### BRIEF DESCRIPTION OF THE DRAWINGS

The above and other objects, features and advantages of the present invention will be more apparent from the following detailed description taken in conjunction with the accompanying drawings. Brief description about the attached drawings are given in order to help full understating of the drawings, in which:

FIG. 1 is a schematic block diagram for illustrating a system for supporting a portable apparatus according to an embodiment of the present invention;

FIG. 2 illustrates a feature table stored in a portable apparatus;

FIG. 3 is a flowchart for illustrating steps of a method for supporting a portable apparatus according to an embodiment of the present invention; and

FIG. 4 is a flowchart for illustrating steps of the downloading method for a portable apparatus according to an embodiment of the present invention.

### DETAILED DESCRIPTION OF THE PREFERRED EMBODIMENTS

Hereinafter, preferred embodiments of the present invention will be described with reference to the accompanying drawings.

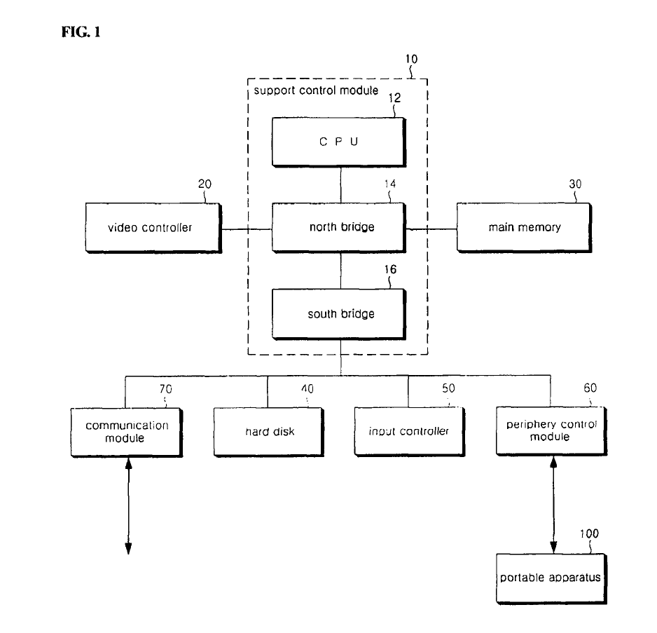

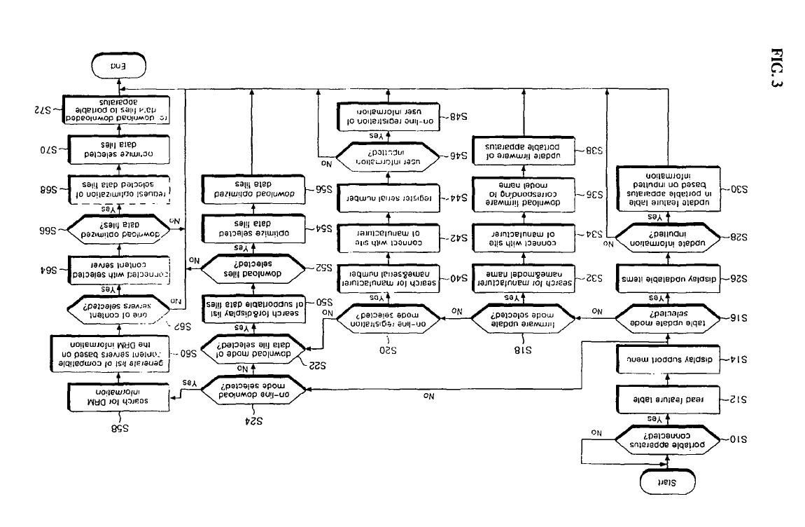

FIG. 1 is a schematic block diagram for illustrating a system for supporting a portable apparatus according to an embodiment of the present invention. The system for supporting a portable apparatus shown in FIG. 1 includes a support control module 10, a video controller 20, a main memory 30, a hard disk 40, an input controller 50, a periphery control module 60, and a communication module 70. The support control module 10 is connected to the video controller 20, the main memory 30, the hard disk 40, the input controller 50, the periphery control module 60, and the communication module 70, respectively, and supports a portable apparatus 100 connected to the input controller 50. Specifically, the support control module 10 downloads update programs to the portable apparatus for maintenance, repair, and function update of the portable apparatus, and downloads reproducible data files to the portable apparatus for viewing or listening of image and/or sound information. Further, the support control module 10 performs user information registration, and downloading of update programs and reproducible data files through the communication module 70. A support operation of the support control module 10 will be described in more detail later with reference to FIG. 3. In addition to the support operation, the support control module 10 controls the video controller 20 the main memory 30, the hard disk 40, the input controller 50, the periphery control module 60, and the communication module 70, and performs data operation and logic operation. To accomplish this the support control module 10 includes a north bridge 14 and a south bridge 16 which are connected in series to a Central Processing Unit (CPU) 12.

The CPU 12 downloads update programs to the portable apparatus 100 for maintenance, repair, and function update of the portable apparatus 100, and downloads reproducible data files to the portable apparatus for viewing or listening of image and/or sound information. Further, the CPU 12 performs user information registration and downloading of update programs and reproducible data files through the communication module 70. In addition, the CPU 12 controls the north bridge 14, the south bridge 16, the video controller 20 the main memory 30, the hard disk 40, the input controller 50, the periphery control module 60, and the communication module 70, and performs data operation and logic operation. To accomplish this, the CPU 12 includes an Arithmetic Logic Unit (ALU), a control unit a register, and a memory device interface.

The north bridge 14 intermediates bidirectional data communication between the CPU 12 and either the south bridge 16 or each of the video controller 20 and the main memory 30 which are relatively rapidly operating peripheral devices. Further, under the control of the CPU 12, the north bridge 14 controls the video controller 20, the main memory 30, and the south bridge 16.

The south bridge 16 is a kind of register assembly which manages inputs and outputs of relatively slowly operating peripheral devices. The south bridge 16 intermediates bidirectional data communication between the CPU 12 connected through the north bridge 14 to the south bridge 16 and each of the hard disk 40, the input controller 50, the periphery control module 60, and the communication module 70. Further, under the control of the CPU 12 connected through the north bridge 14 to the south bridge 16, the south bridge 16 controls the hard disk 40, the input controller 50, the periphery control module 60, and the communication module 70. To accomplish this, the south bridge 16 is connected to the north bridge 14 through a Peripheral Component Interconnect (PCI) bus (not shown).

The video controller 20 enables data processed by the support control module 10 (specifically, the CPU 12) to be displayed on a display unit such as a cathode ray tube or a Liquid Crystal display (LCD). To accomplish this, the video controller 20 may be connected with the north bridge 14 through an Accelerated Graphic Port (AGP).

The main memory 30 arranges a working space for the support control module 10, specifically for the CPU 12. In other words, the main memory 30 temporarily stores data either processed or to be processed by the CPU 12 in the support control module 10. To accomplish this, the main memory 30 is connected with the north bridge 14.

The hard disk 40 stores various programs including an Operating System (OS) program. Various application programs including system programs such as the OS program may be stored in a separate memory called “ReadOnly Memory (ROM).” The OS program stored in the hard disk 40 is uploaded into the main memory 30 and executed by a system booting operation. Various application programs stored in the hard disk 40 are also uploaded into the main memory 30 and executed according to the user's selection.

The input controller 50 transfers data inputted through an input device such as a keyboard or a mouse, through the south bridge 16 and the north bridge 14 to the CPU 12.

The periphery control module 60 controls input and output of data between a support system and the portable apparatus. In other words, the periphery control module 60 intermediates bidirectional data transmission between the support control module 10 (specifically, the CPU 12) and the portable apparatus 100 to be supported. To accomplish this, the periphery control module 60 is connected with the portable apparatus 100 through a Universal Serial Bus (USB).

The communication module 70 intermediates bidirectional communication between the support system and a communication network. Specifically, the communication module 70 transmits data from a public communication network or a local area network to the support control module 10 (that is, transmits the data through the south bridge 16 and the north bridge 14 to the CPU 12) or transmits data from the support control module 10 (that is, the data from the CPU 12 through the north bridge 14 and the south bridge 16) to the public communication network or the local area network. To accomplish this, the communication module 70 is connected with the south bridge 16 through a PCI or USB.

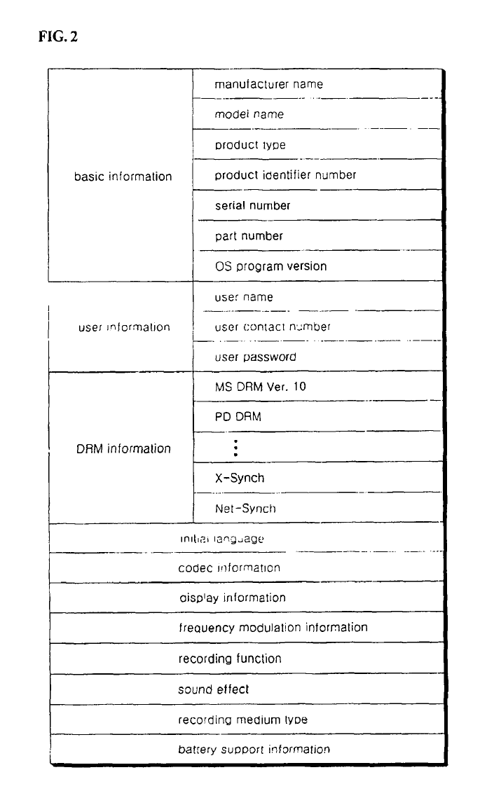

The portable apparatus 100 connected with the periphery control module 60 may be a mobile phone, a portable receiver, a portable reproducer, or a portable phone or receiver which has a reproduction function. For convenience of description, it is assumed that the portable apparatus connected to the periphery control module 60 is a mobile phone which stores a feature table as shown in FIG. 2.

The feature table shown in FIG. 2 includes basic information, user information, and DRM information. The basic information includes the manufacturer name, the model name, the product type, the product identifier number, the serial number, the part number, and the OS program version. The user information includes the user name, the user contact number, and the user password. The user information is recorded by the user. The DRM information includes data about a releasable DRM means from among various DRM means according to manufacturers of data files about image and/or sound information. In addition to the basic information, user information, and DRM information, the feature table may include available initial language, codec information, frequency modulation information, recording function, sound effect, recording medium type, and battery support information.

FIG. 3 is a flowchart for illustrating steps of a method for supporting a portable apparatus according to an embodiment of the present invention. The flowchart shown in FIG. 3 is a flowchart of a program stored in the hard disk 40 included in the support system shown in FIG. 1. which is executed by the support control module 10, specifically by the CPU 12. To this end, the flowchart of FIG. 3 is uploaded from the hard disk 40 to the main memory 30 when the support system is operated. Hereinafter, an operation executed by the support control module 10 according to the flowchart of FIG. 3 will be described in detail with reference to the support system shown in FIG. 1.

The support control module 10 waits for a connection between the periphery control module 60 and the portable apparatus 100 having a reproduction function, while periodically checking the periphery control module 60 (step S10). When the connection of the portable apparatus 100 with the periphery control module 60 is detected, the support control module 10 reads the feature table as shown in FIG. 2, which is stored in the portable apparatus 100, through the periphery control module 60 (step S12). Further, the support control module 10 supplies support menu information to a display device (not shown) through the video controller 20 so that the display device displays the support menu on a screen (step S14). When the support menu is displayed by the display device, a user can select an item from the support menu. Items in the support menu include a table update mode, a firmware update mode, an on-line registration mode, a file downloading mode, and an on-line downloading mode. After the support mode is displayed, the support control module 10 waits for input of a command through an input device (not shown) connected to the input controller 50, which appoints one of the table update mode, the firmware update mode, the on-line registration mode, the file downloading mode, and the on-line downloading mode (steps S16 through S24).

When a command appointing the table update mode is inputted through the input 15 controller 50 in step S16, the support control module 10 supplies information about updatable items through the video controller 20 to the display device, so that the display device can display the updatable items (step S26). The support control module 10 scans the input device connected to the input controller 50, thereby checking if update information is inputted by the user (step S28). When update information has been inputted by the user in step S28, the support control module 10 loads the inputted update information of the user to the portable apparatus 100 connected to the periphery control module 60, thereby updating the information of the corresponding item in the feature table in the portable apparatus 100 by using the inputted information of the user (step S30). In this case, updatable items in the feature table in the portable apparatus 100 include the user name, user contact number, and user password. The update of the feature table by the user can prevent the portable apparatus from being used by another person without permission from the user. In addition, it is possible to update the initial language and frequency modulation information from among the items in the feature table of the portable apparatus 100. The user or a supplier of the portable apparatus can reset the initial language properly for the country in which the portable apparatus will be used. Also, the user or the supplier can reset the frequency modulation information in accordance with the country or environment in which the portable apparatus will be used.

When a command appointing the firmware update mode is inputted from the input controller 50 in step S18, the support control module 10 searches for the manufacturer name of the portable apparatus 100 and the model name from the read feature table (step S32). By using the searched manufacture name of the portable apparatus 100, the support control module 10 connects with the on-line site of the manufacturer of the portable apparatus 100 through the communication network connected with the communication module 70 (step S34). Then, the support control module 10 downloads firmware, corresponding to the searched model name. Irons the on-line site of the corresponding manufacturer (step S36). In this case, the downloaded firmware is temporarily stored in the main memory 30. Thereafter, the support control module 10 re-downloads the downloaded firmware to the portable apparatus 100 connected to the periphery control module 60, thereby updating the firmware in the portable apparatus 100 (step S38). By updating the firmware in the portable apparatus 100 in this way, it becomes possible to easily maintain and repair the portable apparatus 100, easily add a new function to the portable apparatus 100, or easily compensate for an unstable function of the portable apparatus 100.

When a command appointing the on-line registration mode is inputted from the input controller 50 in step S20, the support control module 10 searches for the manufacturer name of the portable apparatus 100 and the serial number of the portable apparatus 100 from the read feature table (step S40). By using the searched manufacture name of the portable apparatus 100, the support control module 10 connects with the on-line site of the manufacturer of the portable apparatus 100 through the communication network connected with the communication module 70 (step S42). Then, the support control module 10 transmits the searched serial number of the portable apparatus 100 to the on-line site of the manufacturer of the portable apparatus 100 and registers the searched serial number in the on-line site of the manufacturer of the portable apparatus 100 (step S44). Thereafter, the support control module 10 scans the input device connected to the input controller 50 and checks if information relating to the user (i.e. user information) is inputted (step S46). When user information has been inputted in step S46, the support control module 10 transmits the inputted user information through the communication module 70 and the communication network to the on-line site of the manufacturer of the portable apparatus 100. thereby registering the user information in the on-line site of the manufacturer (step S48). The user information includes the user name, user address, and the telephone number of the portable apparatus 100. The registration of the user information enables tracing of a lost or stolen portable apparatus, thereby preventing loss or robbery of the portable apparatus. Moreover, the registration of the user information enables tracing of illegal distribution of the portable apparatus, including sale of a stolen apparatus with removal of its serial number label and dumping of the apparatus by an illegal seller. Further, after the user information is registered in the on-line site of the manufacturer, the support control module 10 may download an electronic coupon from the on-line site of the manufacturer through the communication network and the communication module 70 (step S48-1). Then, the support control module 10 may transmit the downloaded coupon through the periphery control module 60 to the portable apparatus 100 so that the coupon can be stored in the portable apparatus 100. The downloading of the coupon can prevent illegal use of the coupon through forgery or falsification of a sheet-type coupon and loss of privilege due to loss of the sheet-type coupon.

When a command appointing the file downloading mode is inputted in step S22, the support control module 10 searches for data files, which are reproducible in the portable apparatus 100, from among the data files relating to image and/or sound information stored in the hard disk 40, based on the DRM information in the feature table. Further, the support control module 10 generates a list of searched data files and transmits the generated data file list to the display device through the video controller 20, so that the display device can display the reproducible data file list (step S50). Then, the support control module 10 scans the input device connected to the input controller 50 and checks if theme exist appointed data files to be downloaded from among the files in the reproducible data file list (step S52). When there exist appointed data files to be downloaded in step S52, the support control module 10 reads the appointed data files from the hard disk 40 and optimizes the data tiles to be proper for reproduction by the portable apparatus 100 (step S54). Further, the support control module 10 causes the optimized data files to be downloaded to the portable apparatus 100 through the periphery control module 60 (step S56). Therefore, it is possible to select only the data files of the releasable DRM means from among the data files relating to the image and/or sound information stored in the hard disk 40. As a result, the user can easily download the reproducible data files to the portable apparatus 100.

When a command appointing the on-line downloading mode is inputted in step S24, the support control module 10 searches for the DRM information in the read feature table (step S58).

Based on the searched DRM information, the support control module 10 generates a list of content servers which are compatible with the portable apparatus 100 (step S60). Further, the support control module 10 scans input devices connected to the input controller 50 and checks if there exists an appointed content server to be accessed from among the content servers in the compatible content server list (step S62). When there exists an appointed content server to be accessed in step S62, the support control module 10 connects with the selected content server through the communication module 70 and the communication network, and transmits a list of data files relating to image and/or sound information provided by the connected content server to the display device through the video controller 20, so that the display device can display the data file list (step S64). Then, the user can select a data file or data files from the data file list provided by the connected compatible content server. After performing step S64, the support control module 10 scans the input devices connected to the input controller 50, and determines if there exist appointed data files to be downloaded from among the data files in the data file list of the content server (step S66). When there exist appointed data files to be downloaded in step S66, the support control module 10 can request optimization of the appointed data files to the connected content server (step S68). When there is a request for optimization of the appointed data files, the content server optimizes the data files and transmits the optimized data files through the communication network to the communication module 70 of the support system. Then, the support control module 10 downloads the optimized data files from the content server connected through the communication network and the communication module 70 (step S70). When there is no request for optimization of the appointed data files, the support control module 10 downloads the data files in a state, in which the files are not optimized, from the content server. Thereafter, the support control module 10 enables the data files downloaded from the content server to be downloaded again to the portable apparatus 100 through the periphery control module 60 (step S72). By guiding selection of content servers which are compatible with the portable apparatus 100 in the way described above, the support control module 10 makes it possible to download on-line only the data files reproducible in the portable apparatus 100. Further, the support control module 10 enables a user to easily download on-line data files which the user wants.

The program of FIG. 3, which implements a method for supporting a portable apparatus, as described above, may be stored in the portable apparatus instead of the hard disk 40 of the support system shown in FIG. 1. In this case, the support system for the portable apparatus may be replaced by a typical personal computer. Further, when the portable apparatus is connected with the support system (i.e. personal computer), a program for a downloading method stored in the portable apparatus 100 may be first downloaded to the hard disk 40 of the support system (i.e. personal computer) and then uploaded to the main memory 30, so that the support control module 10 can execute the program.

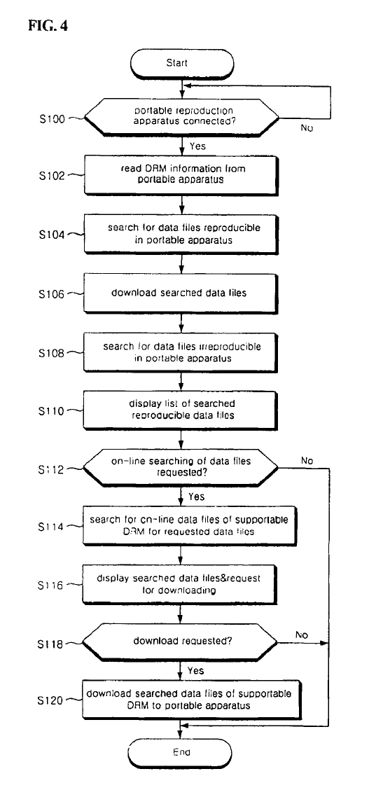

FIG. 4 is a flowchart for illustrating steps of the downloading method for a portable apparatus according to an embodiment of the present invention. The flowchart shown in FIG. 4 is a flowchart of a program stored in the hard disk 40 included in the support system shown in FIG. 1, which is executed by the support control module 10, specifically by the CPU 12. To this end, the flowchart of FIG. 4 is uploaded from the hard disk 40 to the main memory 30 when the support system is operated. Hereinafter, an operation executed by the support control module 10 according to the flowchart of FIG. 4 will be described in detail with reference to the support system shown in FIG. 1.

The support control module 10 waits for connection between the periphery control module 60 and the portable apparatus 100 having a reproduction function, while periodically checking the periphery control module 60 (step S100). When the connection of the portable apparatus 100 with the periphery control module 60 is detected, the support control module 10 reads DRM information from the feature table as shown in FIG. 2, which is stored in the portable apparatus 100, through the periphery control module 60 (step S102).

Then, based on the read DRM information, the support control module 10 searches for data files, which can be reproduced in the portable apparatus 100, from among the data files relating to the image and/or sound information stored in the hard disk 40 (step S104). Further, the support control module 10 downloads the searched data files to the portable apparatus 100 through the periphery control module 60 (step S106). In steps S104 and S106, from among the data files relating to the image and/or sound information stored in the hard disk 40, only the data files of the releasable DRM means are automatically downloaded to the portable apparatus 100.

After performing step S106, the support control module 10 searches for data files, which cannot be reproduced in the portable apparatus 100, from among the data files relating to the image and/or sound information stored in the hard disk 40 (step S108). Further, the support control module 10 generates a list of data files which cannot be reproduced, and transmits the generated irreproducible data file list to the display device through the video controller 20, so that the video controller 20 can display the irreproducible data file list (step S110). Then, the user can select data files to be downloaded from among the irreproducible data files in the list. Then, the support control module 10 scans the input devices connected to the input controller 50 and determines if there exists at least one appointed data file in the irreproducible data file list (step S112). When there exists at least one appointed data file in the irreproducible data file list step S112, the support control module 10 connects with a content server compatible with the portable apparatus 100 through the communication module 70 and the communication network based on the read DRM information and searches for a data file of the reproducible DRM means corresponding to the appointed data file (step S114). Further, the support control module 10 transmits a search result of the reproducible data file corresponding to the appointed data file to the display device through the video controller 20 and the display device displays the search result, so that the user can determine whether to perform the on-line downloading (step S116). Thereafter, the support control module 10 scans the input devices connected to the input controller 50 and determines if there is a command for on-line download of the searched data file (step S118). When there is a command for on-line download of the searched data file in step S118, the support control module 10 receives the searched reproducible data file from the content server through the communication network and the communication module 70, and downloads the received data file to the portable apparatus 100 through the periphery control module 60 (step S120). In steps S108 through S120, reproducible data files corresponding to the irreproducible data files stored in the hard disk 40 are automatically searched for on-line based on the DRM information of the portable apparatus 100, and the reproducible data files which the user wants are downloaded to the portable apparatus 100.

The program of FIG. 4, which implements a method for supporting a portable apparatus. as described above, may be stored in the portable apparatus instead of the hard disk 40 of the support system shown in FIG. 1. In this case, the support system for the portable apparatus may be replaced by a typical personal computer. Further, when the portable apparatus is connected with the support system (i.e. personal computer), a program for a downloading method stored in the portable apparatus 100 may be first downloaded to the hard disk 40 of the support system (i.e. personal computer) and then uploaded to the main memory 30, so that the support control module 10 can execute the program.

As described above, in the system and method for supporting a portable apparatus according to the present invention, it is possible to update items in a feature table, such as user name, user contact number, and user password, so as to prevent illegal use of the portable apparatus by an unauthorized person. In addition, it is also possible to update the items of initial language and frequency modulation information in the feature table of the portable apparatus 100. Therefore, in the system and method for supporting a portable apparatus according to the present invention, it is possible to reset the used language and frequency band according to the country or environment in which the portable apparatus will be used.

In the system and method for supporting a portable apparatus according to the present invention, it is possible to update firmware of the portable apparatus 100, which makes it possible to easily perform maintenance/repair, addition of new function, and update of unstable function of the portable apparatus 100.

In the system and method for supporting a portable apparatus according to the present invention, the serial number of the portable apparatus, user name, user address and telephone number. etc. are registered on-line. Therefore, it is possible to trace a lost or stolen portable apparatus, thereby preventing loss or robbery of the portable apparatus. Moreover, according to the present invention, it is possible to trace illegal distribution of the portable apparatus, including sale of a stolen apparatus with removal of its serial number label and dumping of the apparatus by an illegal seller. Further, it is also possible to download an electronic coupon after the on-line registration of the user information, which can prevent illegal use of the coupon through forgery or falsification of a sheet-type coupon and loss of privilege due to loss of the sheet-type coupon.

In the system and method for supporting a portable apparatus according to the present invention, it is possible to select only the data files of the releasable DRM means from among the data files relating to the image and/or sound information stored in the hard disk 40, so that the user can easily download the reproducible data files to the portable apparatus 100. The system and method for supporting a portable apparatus according to the present invention guide selection of content servers which are compatible with the portable apparatus 100, so that the user can easily download on-line data files which the user wants.

In the system and method for supporting a portable apparatus according to the present invention, only the data files of the releasable DRM means, which can be released by the portable apparatus, are automatically downloaded, from among the data files relating to the image and/or sound information stored in advance. Further, in the system and method for supporting a portable apparatus according to the present invention, reproducible data files corresponding to the irreproducible data files stored in the hard disk 40 are automatically searched for on-line based on the DRM information of the portable apparatus, and the reproducible data files which the user wants arc downloaded to the portable apparatus.

Further, the method for supporting a portable apparatus according to the present invention can be stored in the portable apparatus, so that a personal computer can be used as the system for supporting the portable apparatus according to the present invention. Also, a downloading method for a portable apparatus according to the present invention can be stored in the portable apparatus, so that a personal computer can be used as the system for supporting the portable apparatus according to the present invention.

Although preferred embodiments of the present invention has been described for illustrative purposes, those skilled in the art will appreciate that various modifications, additions and substitutions are possible without departing from the scope and spirit of the invention as disclosed in the accompanying claims.

What is claimed is:

1. A system for supporting a portable apparatus which stores a feature table including Digital Right Management (DRM) information, the system comprising:
a periphery control module for controlling the portable apparatus;
a communication module for intermediating communication with a communication network;
an input controller for inputting a command from a user; and
a control module which reads the DRM information from the portable apparatus, searches for on-line a data file appointed through the input controller by the user based on the read DRM information and downloads the searched data file to the portable apparatus through the periphery control module, when a connection of the portable apparatus with the periphery control module is detected.

2. The system as claimed in claim 1, wherein the control module connects through the communication module and the communication network with a content server compatible with the portable apparatus and searches for the appointed data file in the content server based on the DRM information and downloads the searched data file to the portable apparatus upon receiving a download command for the searched data file.

3. The system as claimed in claim 2, wherein the control module requests optimization of the data file to the content server before the data file is downloaded, so that an optimized data file can be downloaded to the portable apparatus.

4. A system for supporting a portable apparatus which stores a feature table including Digital Right Management (DRM) information, the system comprising:
a periphery control module for controlling the portable apparatus;
a communication module for intermediating communication with a communication network;
a memory storing data files;
an input controller for controlling input of a command; and
a control module which reads the DRM information from the portable apparatus, and downloads data file reproducible by the portable apparatus from among the data milks stored in the memory to the portable apparatus based on the read DRM information, when a connection of the portable apparatus with the periphery control module is detected.

5. The system as claimed in claim 4, wherein the control module searches for on-line reproducible data files corresponding to data files irreproducible by the portable apparatus through the communication module and the communication network based on the read DRM information, and downloads the on-line searched data tiles to the portable apparatus through the periphery control module.

6. The system as claimed in claim 5, wherein the control module connects through the communication module and the communication network with a content server compatible with the portable apparatus, searches for the reproducible data files corresponding to the irreproducible data files in the content server based on the DRM information and downloads the searched reproducible data files to the portable apparatus.

7. The system as claimed in claim 6, wherein the control module searches only irreproducible data files appointed through the input controller in order to find the reproducible data files corresponding to the irreproducible data files.

8. A system for supporting a portable apparatus which stores a feature table including a manufacturer name and a model name, the system comprising:
a periphery control module for controlling the portable apparatus:
a communication module for intermediating communication with a communication network; and
a control module which reads the manufacturer name and the model name from the portable apparatus, and downloads firmware corresponding to the model name to the portable apparatus from a site corresponding to the manufacturer name through the communication module and the communication network, when a connection of the portable apparatus with the periphery control module is detected.

9. A system for supporting a portable apparatus which stores a feature table including a manufacturer name, a model name, and a serial number, the system comprising:
a periphery control module for controlling the portable apparatus;
a communication module for intermediating communication with a communication network;
an input controller for controlling input of a command: and
a control module which reads the manufacturer name, the model name, and the serial number from the portable apparatus, registers the serial number in an on-line site of a manufacturer through the communication module and the communication network based on the manufacturer name, and registers user information from the input controller to the on-line site of the manufacturer, when a connection of the portable apparatus with the periphery control module is detected.

10. The system as claimed in claim 9, wherein the control module downloads an electronic coupon to the portable apparatus from the on-line site of the manufacturer, after registering the user information.

11. A system for supporting a portable apparatus which stores a feature table including a manufacturer name, a model name, a serial number, and Digital Right Management (DRM) information, the system comprising:
a periphery control module for controlling the portable apparatus;
a communication module for intermediating communication with a communication network;
a memory storing data files;
an input controller for controlling input of a command; and
a control module which reads the feature table from the portable apparatus, and selectively performs a table update mode, a firmware update mode, an on-line registration mode, a data file download mode, and an on-line download mode, when a connection of the portable apparatus with the periphery control module is detected,
wherein the control module updates updatable items in the feature table of the portable apparatus in response to a command from the input controller in the table update mode, downloads firmware from a site of a manufacturer to the portable apparatus through the communication module by using the manufacturer name and the model name in the feature table in the firmware update mode, registers the serial number and user information in the site of the manufacturer through the communication module by using the manufacturer name in the feature table in the on-line registration mode, downloads reproducible data files from among the data files stored in the memory to the portable apparatus based on the DRM information in the feature table in the data file download mode, and downloads data files from a compatible content server through the communication module to the portable apparatus based on the DRM information in the on-line download mode.

12. A method for supporting a portable apparatus, comprising the steps of.:
(1) determining if a portable apparatus storing a feature table including Digital Right Management (DRM) information connects with a periphery control module;
(2) reading the DRM information from the portable apparatus;
(3) searching for a data file appointed through an input controller by a user based on the read DRM information on-line through a communication module and a communication network-, and
(4) downloading the searched data file to the portable apparatus through the periphery control module.

13. The method as claimed in claim 12, wherein step (3) comprises the steps of:
connecting the communication module with a content server, which is compatible with the portable apparatus, through the communication network based on the DRM information; and
searching for the data file appointed by the content server.

14. The method as claimed in claim 12, wherein step (4) comprises the steps of:
requesting optimization of the data file to be downloaded to the content server; and
receiving an optimized data file from the content server.

15. A method for supporting a portable apparatus, comprising the steps of:
waiting for a connection of a portable apparatus storing a feature table including Digital Right Management (DRM) information connects with a periphery control module of a downloading system;
reading the DRM information from the portable apparatus; and
downloading data files reproducible by the portable apparatus from among data files stored in a memory of the downloading system to the portable apparatus based on the read DRM information.

16. The method as claimed in claim 15, further comprising the steps of:
(a) searching for data files irreproducible by, the portable apparatus based in the DRM information;
(b) searching for the reproducible data files corresponding to the irreproducible data files based on the read DRM information on-line through a communication module and a communication network; and
(c) downloading the on-line searched reproducible data files to the portable apparatus through the periphery control module.

17. The method as claimed in claim 16, wherein step (b) comprises the steps of:
connecting the communication module with a content server, which is compatible with the portable apparatus, through the communication network based on the DRM information; and
searching for the reproducible data files corresponding to the irreproducible data files in the compatible content server.

18. The method as claimed in claim 17, wherein step (b) is performed only for irreproducible data files appointed through an input controller.

19. A method for supporting a portable apparatus, comprising the steps of:
determining if a portable apparatus storing a feature table including a manufacturer name and a model name is connected with a periphery control module;
reading the DRM information from the portable apparatus and connecting with a site corresponding to the manufacturer name through a communication module and a communication network based on the manufacturer name; and
downloading firmware corresponding to the model name to the portable apparatus from the site corresponding to the manufacturer name.

20. A method for supporting a portable apparatus, comprising the steps of
determining if a portable apparatus storing a feature table including a manufacturer name, a model name, and a serial number, is connected with a periphery control module:
reading the manufacturer name, the model name, and the serial number from the portable apparatus;
registering the serial number in a site of a manufacturer through a communication network based on the manufacturer name; and
registering user information to the on-line site of the manufacturer through the communication network.

21. The method as claimed in claim 20, further comprising the step of downloading an electronic coupon to the portable apparatus from the on-line site of the manufacturer, after registering the user information.

22. A method for supporting a portable apparatus, comprising the steps of:
determining if a portable apparatus storing a feature table including a manufacturer name. a model name, a serial number, and Digital Right Management (DRM) information, is connected with a periphery control module;
reading the feature table from the portable apparatus;
receiving a command from a user; and
selectively performing a table update mode, a firmware update mode, an on-line registration mode, a data file download mode, and an on-line download mode, in response to the command from the user,
wherein updatable items in the feature table of the portable apparatus are updated in response to the command from the user in the table update mode, firmware are downloaded from a site of a manufacturer to the portable apparatus through the communication module by using the manufacturer name and the model name in the feature table in the firmware update mode, the serial number and user information are registered in the site of the manufacturer through the communication module by using the manufacturer name in the feature table in the on-line registration mode, reproducible data files from among the data files stored in the memory are downloaded to the portable apparatus based on the DRM information in the feature table in the data file download mode, and data files from a compatible content server through the communication module are downloaded to the portable apparatus based on the DRM information in the on-line download mode.

23. A recording medium storing a downloading program for executing a method in a portable apparatus storing a feature table including Digital Right Management (DRM) information, the method comprising the steps of:
waiting for a connection of the portable apparatus with a periphery control module of a support system,
reading the DRM information from the portable apparatus;
downloading data files reproducible by the portable apparatus from among data files stored in a memory of the downloading system to the portable apparatus based on the read DRM information;
searching for data files irreproducible by the portable apparatus based on the DRM information:
searching for the reproducible data files corresponding to the irreproducible data files based on the read DRM information on-line through a communication module and a communication network; and
downloading the on-line searched reproducible data files to the portable apparatus through the periphery control module.

24. A portable apparatus comprising the recording medium as claimed in claim 23.

25. A recording medium storing a support program for executing a method which comprises the steps of:
determining if a portable apparatus storing a feature table including a manufacturer name, a model name, a serial number, and Digital Right Management (DRM) information, is connected with a periphery control module,
reading the feature table from the portable apparatus:
receiving a command from a user: and
selectively performing a table update mode, a firmware update mode, an on-line registration mode, a data file download mode, and an on-line download mode, in response to the command from the user,
wherein updatable items in the feature table of the portable apparatus are updated in response to the command from the user in the table update mode, firmware are downloaded from a site of a manufacturer to the portable apparatus through the communication module by using the manufacturer name and the model name in the feature table in the firmware update mode, the serial number and user information are registered in the site of the manufacturer through the communication module by using the manufacturer name in the feature table in the on-line registration mode, reproducible data files from among the data files stored in the memory are downloaded to the portable apparatus based on the DRM information in the feature table in the data file download mode, and data files from a compatible content server through the communication module are downloaded to the portable apparatus based on the DRM information in the on-line download mode.

26. A portable apparatus comprising the recording medium as claimed in claim 25.
